(19) United States
(12) Patent Application Publication
(10) Pub. No.: US 2026/0280020 A1
(43) Pub. Date: Sep. 17, 2026

(54) THERMAL BARRIER-TO-COVER ADHESIVE JOINT DESIGNS FOR TRACTION BATTERY PACKS

(71) Applicant: FORD GLOBAL TECHNOLOGIES, LLC, Dearborn, MI (US)

(72) Inventors: Kuo Sun, Novi, MI (US); Patrick Daniel Maguire, Ann Arbor, MI (US); Deanna Marie Winton Hoffman, Ann Arbor, MI (US); Kirk Pfannes, Utica, MI (US)

(21) Appl. No.: 19/078,414

(22) Filed: Mar. 13, 2025

(51) Int. Cl. H01M 50/291; B60L 50/64; H01M 10/658; H01M 50/211; H01M 50/271; H01M 50/293

(52) U.S. Cl. CPC H01M 50/291; B60L 50/64; H01M 10/658; H01M 50/211; H01M 50/271; H01M 50/293; H01M 2220/20

(57) ABSTRACT

Thermal barrier assemblies are provided for inhibiting the transfer of thermal energy and for increasing the structural integrity of a traction battery pack. An exemplary thermal barrier assembly may include a structural barrier that is configured to establish an adhesive joint inside the traction battery pack. The structural barrier may include a combination of features that provide a pocket for receiving an adhesive that can secure an enclosure structure to the structural barrier.

### TECHNICAL FIELD

This disclosure relates generally to traction battery packs, and more particularly to thermal barrier assemblies that include structural barriers for establishing adhesive joints inside traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, and a thermal barrier assembly arranged to partition the battery cell stack into at least a first compartment and a second compartment. A structural barrier of the thermal barrier assembly includes an upper interfacing structure that provides a pocket, and an adhesive is received within the pocket for structurally coupling the upper interfacing structure to an upper enclosure structure of the traction battery pack.

In a further non-limiting embodiment of the foregoing traction battery pack, the upper enclosure structure is part of an enclosure cover of the traction battery pack.

In a further non-limiting embodiment of either of the foregoing traction battery packs, the structural barrier includes a T-shaped cross-section.

In a further non-limiting embodiment of any of the foregoing traction battery packs, the structural barrier is a pultrusion.

In a further non-limiting embodiment of any of the foregoing traction battery packs, the structural barrier is part of a multi-layer sandwich structure of the thermal barrier assembly.

In a further non-limiting embodiment of any of the foregoing traction battery packs, the upper interfacing structure includes an upper surface and a pair of beads that protrude outwardly from the upper surface, and the upper surface and the pair of beads cooperate to establish the pocket.

In a further non-limiting embodiment of any of the foregoing traction battery packs, each bead of the pair of beads extends to a height above the upper surface, and the adhesive includes a thickness that is about equal to the height.

In a further non-limiting embodiment of any of the foregoing traction battery packs, an additional bead protrudes from the upper surface at a location between a first bead of the pair of beads and a second bead of the pair of beads.

In a further non-limiting embodiment of any of the foregoing traction battery packs, the structural barrier includes a lower interfacing structure that is connected to the upper interfacing structure and is configured to interface with a lower enclosure structure of the traction battery pack.

In a further non-limiting embodiment of any of the foregoing traction battery packs, the structural barrier includes a buttress that extends between the lower interfacing structure and the upper interfacing structure.

In a further non-limiting embodiment of any of the foregoing traction battery packs, the upper interfacing structure includes an upper surface and a pair of wiper gaskets that protrude outwardly from the upper surface.

In a further non-limiting embodiment of any of the foregoing traction battery packs, the upper interfacing structure includes an upper surface and a pair of flaps that are movably connected to the upper interfacing structure.

In a further non-limiting embodiment of any of the foregoing traction battery packs, the upper interfacing structure includes a first wall section and a second wall section that are each pivotably connected to a lower interfacing structure of the structural barrier.

A traction battery pack according to another exemplary aspect of the present disclosure includes, among other things, an upper enclosure structure, and a thermal barrier assembly including a structural barrier configured to establish a first sealed interface relative to the upper enclosure structure. The structural barrier includes an upper interfacing structure that includes a pocket, and an adhesive is received within the pocket for securing the upper enclosure structure to the structural barrier.

In a further non-limiting embodiment of the foregoing traction battery pack, the structural barrier is a pultruded structure of the thermal barrier assembly.

In a further non-limiting embodiment of either of the foregoing traction battery packs, the upper interfacing structure includes an upper surface and a first bead and a second bead that each protrudes outwardly from the upper surface.

In a further non-limiting embodiment of any of the foregoing traction battery packs, a third bead protrudes outwardly from the upper surface at a location between the first bead and the second bead.

In a further non-limiting embodiment of any of the foregoing traction battery packs, the upper interfacing structure includes an upper surface and a pair of wiper gaskets that protrude outwardly from the upper surface.

In a further non-limiting embodiment of any of the foregoing traction battery packs, the upper interfacing structure includes an upper surface and a pair of flaps that are movably connected to the upper interfacing structure.

In a further non-limiting embodiment of any of the foregoing traction battery packs, the upper interfacing structure includes a first wall section and a second wall section that are each pivotably connected to a lower interfacing structure of the structural barrier.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view of select portions of a cell stack of a traction battery pack.

FIG. 4 illustrates a structural barrier of a thermal barrier assembly of the cell stack of FIG. 3.

FIG. 5 illustrates another exemplary structural barrier of a thermal barrier assembly.

FIG. 6 illustrates another exemplary structural barrier of a thermal barrier assembly.

FIG. 7 illustrates another exemplary structural barrier of a thermal barrier assembly.

FIG. 8 illustrates another exemplary structural barrier of a thermal barrier assembly.

FIG. 9 illustrates another exemplary structural barrier of a thermal barrier assembly.

FIG. 10 illustrates another exemplary structural barrier of a thermal barrier assembly.

FIG. 11 illustrates another exemplary structural barrier of a thermal barrier assembly.

FIG. 12 illustrates yet another exemplary structural barrier of a thermal barrier assembly.

### DETAILED DESCRIPTION

This disclosure is directed to thermal barrier assemblies configured for inhibiting the transfer of thermal energy and for increasing the structural integrity of a traction battery pack. An exemplary thermal barrier assembly may include a structural barrier that is configured to establish an adhesive joint inside the traction battery pack. The structural barrier may include a combination of features that provide a pocket for receiving an adhesive that can secure an enclosure structure to the structural barrier. These and other features are discussed in greater detail in the following paragraphs of this detailed description.

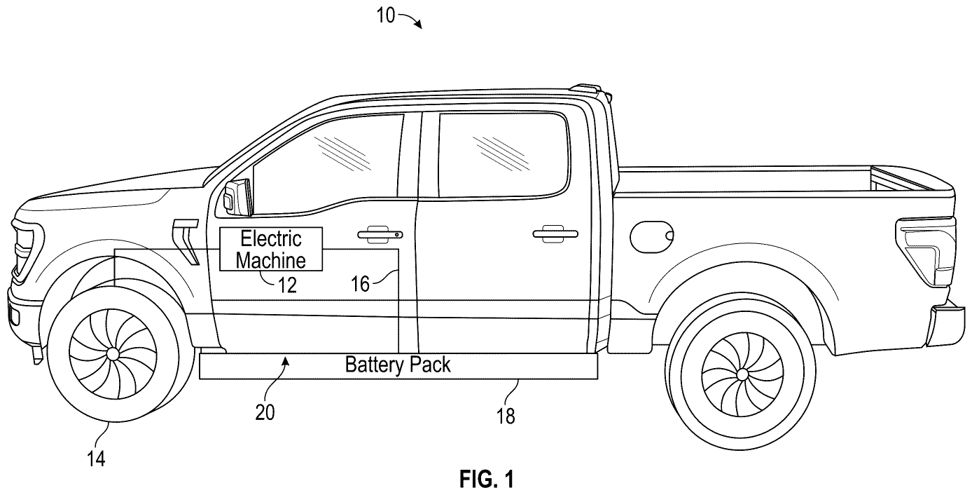

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

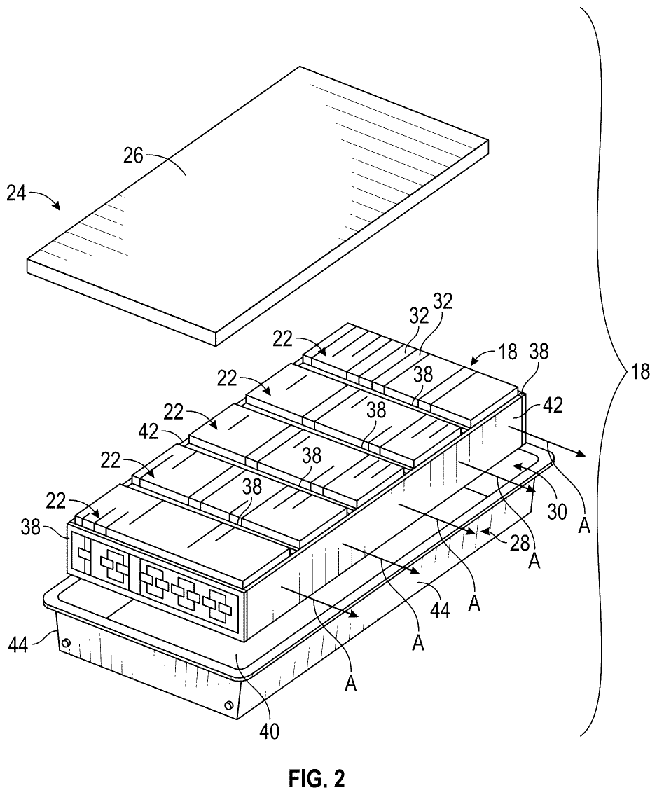

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together side-by-side relative to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged to extend laterally between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

Each cell stack 22 may be arranged to extend along its respective cell stack axis A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

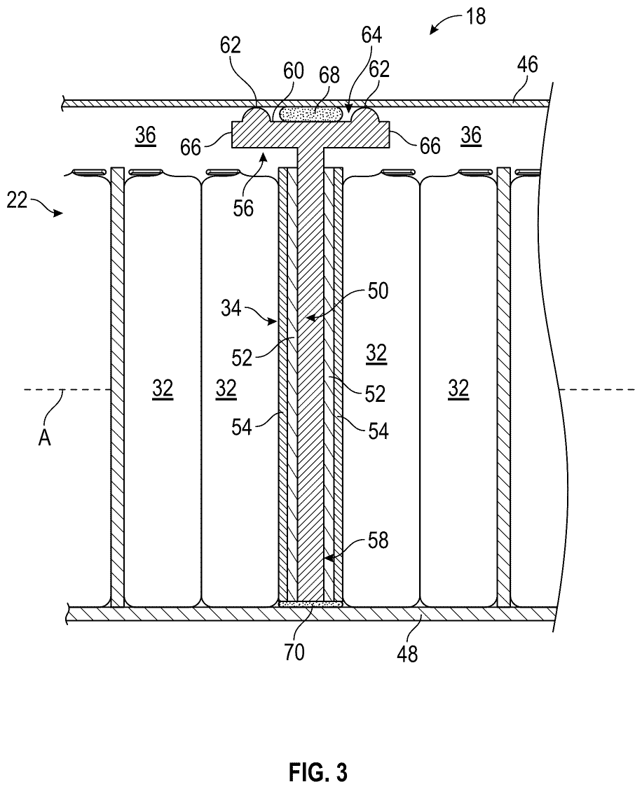

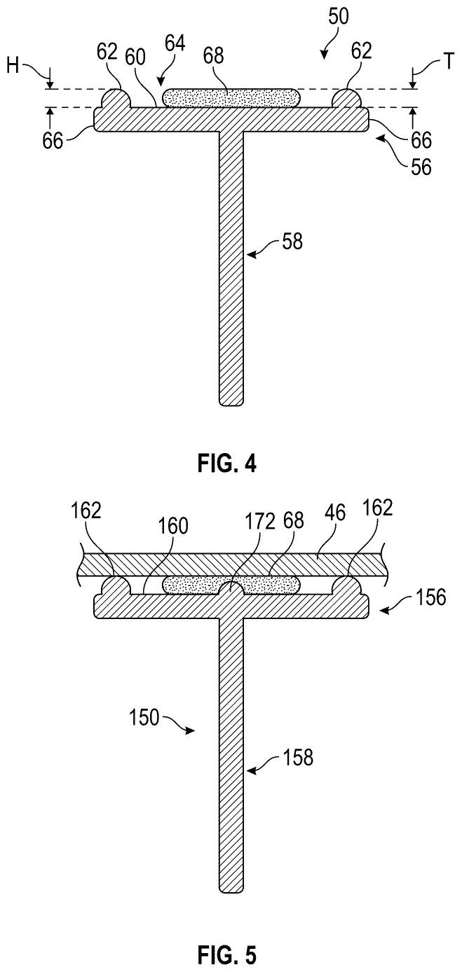

Referring now to FIGS. 3 and 4, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22.

Should, for example, a battery thermal event occur in one of the compartments 36, the thermal barrier assemblies 34 can reduce or even prevent thermal energy associated with the thermal event from moving from cell-to-cell, compartment-to-compartment, and/or cell stack-to-cell stack, thereby inhibiting the transfer of thermal energy inside the traction battery pack 18.

Each thermal barrier assembly 34 may be configured to establish a sealed interface relative to both an upper enclosure structure 46 and a lower enclosure structure 48 of the traction battery pack 18. The upper enclosure structure 46 may be part of the enclosure cover 26 of the enclosure assembly 24 or could alternatively be an intermediate structure (e.g., a cell stack cover, a heat exchanger plate, etc.) that is positioned between the thermal barrier assembly 34 and the enclosure cover 26. The lower enclosure structure 48 may be part of the heat exchanger plate 40 that is positioned between the thermal barrier assembly 34 and the enclosure tray 28 or could be part of the enclosure tray 28.

Each thermal barrier assembly 34 may include a structural barrier 50. The structural barrier 50 may include a thermoplastic structure or a polymer composite structure (e.g., glass fiber reinforced polypropylene with an intumescent additive), for example.

The structural barrier 50 may optionally be flanked by additional layers as part of a multi-layer sandwich structure of the thermal barrier assembly 34. In an embodiment, the structural barrier 50 is flanked by thermal resistance material layers 52 and/or foam layers 54 as part of the multi-layer sandwich structure. The thermal resistance material layers 52 may include aerogel layers or mica sheets, for example, and the foam layers 54 may include polyurethane foam or silicone foam, for example. However, other materials or combinations of materials could be utilized to construct the subcomponents of the thermal barrier assembly 34 within the scope of this disclosure.

The structural barrier 50 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

The structural barrier 50 of the thermal barrier assembly 34 may include an upper interfacing structure 56 that is configured to interface with the upper enclosure structure 46, and a lower interfacing structure 58 that is configured to interface with lower enclosure structure 48. The lower interfacing structure 58 may be integrally formed with the upper interfacing structure 56 to provide a unitary part. Together, the upper interfacing structure 56 and the lower interfacing structure 58 may establish a T-shaped cross-section of the structural barrier 50. However, other shapes are contemplated within the scope of this disclosure.

The upper interfacing structure 56 may include an upper surface 60 and a pair of beads 62 that protrude outwardly from the upper surface 60. One bead 62 may be provided near each outboard edge 66 of the upper interfacing structure 56.

The upper surface 60 and the beads 62 may cooperate to establish a pocket 64 for receiving and holding an adhesive 68. The adhesive 68 can secure the thermal barrier assembly 34 and the upper enclosure structure 46 together. The adhesive 68 may be a structural adhesive, such as an epoxy based adhesive or a urethane based adhesive, for example. However, other types of adhesive are contemplated within the scope of this disclosure.

The beads 62 may each extend to a height H that is proud of at least a portion of the adhesive 68 and can thus function to prevent the adhesive 68 from flowing or dripping off of the upper interfacing structure 56 prior to curing. The beads 62 may additionally function to support the upper enclosure structure 46 and can act as depth stops and/or compression limiters as the upper enclosure structure 46 is moved into contact with the structural barrier 50 during assembly of the traction battery pack 18.

The adhesive 68 may include a thickness T. The thickness T may be about equal to the height H of the beads 62 in order to provide a more uniform adhesive bond line between the upper enclosure structure 46 and the structural barrier 50 of the thermal barrier assembly 34. In this disclosure, the term “about” means that the expressed quantities or ranges need not be exact but may be approximated and/or larger or smaller, reflecting acceptable tolerances, conversion factors, measurement error, etc.

Once the upper enclosure structure 46 is secured to the structural barrier 50 by the adhesive 68, the sealed joint established therebetween can substantially prevent thermal energy from moving from one compartment 36 to another, such as during a battery thermal event, for example. The beads 62 may directly contact the upper enclosure structure 46 to provide additional sealing, thereby acting as barriers that can prevent thermal energy from melting or debonding the adhesive 68 during such a battery thermal event.

The lower interfacing structure 58 may extend to an opposite end of the structural barrier 50 from the upper interfacing structure 56. The lower interfacing structure 58 may be substantially flat or could include a notched section configured for accommodating a contour of the lower enclosure structure 48.

The lower interfacing structure 58 may be fixedly secured to the lower enclosure structure 48 to increase the overall rigidity of the traction battery pack 18. A thermal interface material 70, which could be an adhesive or an insulation material, may be utilized to secure the lower interfacing structure 58 to the lower enclosure structure 48. The thermal interface material 70 could including sealing properties. The thermal interface material 70 (e.g., epoxy resin, silicone based materials, thermal greases, etc.) may additionally be disposed between the battery cells 32 of the cell stack 22 and the lower enclosure structure 48 for facilitating heat transfer therebetween.

Once the upper interfacing structure 56 is joined to the upper enclosure structure 46 and the lower interfacing structure 58 is joined to the lower enclosure structure 48, the upper and lower enclosure structures 46, 48 are effectively structurally coupled to one another. The structural barrier 50 of the thermal barrier assembly 34 is therefore uniquely configured for increasing the structural stiffness of the traction battery pack 18.

FIG. 5 illustrates another exemplary structural barrier 150 that could be utilized as part of the thermal barrier assembly 34 described above. The structural barrier 150 is similar to the structural barrier 50 of FIGS. 3-4 and therefore includes an upper interfacing structure 156, a lower interfacing structure 158, and a pair of beads 162. However, in this embodiment, the structural barrier 150 includes an additional bead 172 that protrudes outwardly from an upper surface 160 of the upper interfacing structure 156. The bead 172 may protrude from the upper surface 160 at a location that is axially aligned to the lower interfacing structure 158 of the structural barrier 150. The bead 172 is therefore positioned to direct columnar loads from the upper enclosure structure 46 through the structural barrier 150 by establishing a more direct vertical load path through the lower interfacing structure 158.

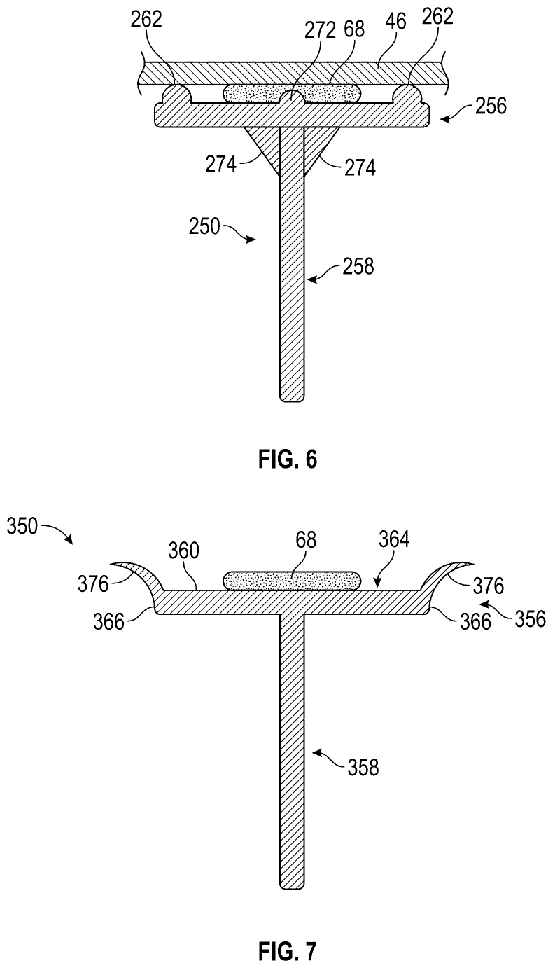

FIG. 6 illustrates another exemplary structural barrier 250 that could be utilized as part of the thermal barrier assembly 34 described above. The structural barrier 250 is similar to the structural barrier 150 of FIG. 5 and therefore includes an upper interfacing structure 256, a lower interfacing structure 258, beads 262, and a bead 272. However, in this embodiment, the structural barrier 250 may include one or more buttresses 274 that extend diagonally between the lower interfacing structure 258 and the upper interfacing structure 256 of the structural barrier 250. The buttresses 274 may be configured to increase the structural integrity of the upper interfacing structure 256, thereby allowing the structural barrier 250 to better support the weight of the upper enclosure structure 46.

FIG. 7 illustrates another exemplary structural barrier 350 that could be utilized as part of the thermal barrier assembly 34 described above. The structural barrier 350 may include an upper interfacing structure 356 that is configured to interface with an upper enclosure structure of the traction battery pack 18, and a lower interfacing structure 358 that is configured to interface a lower enclosure structure of the traction battery pack 18. Together, the upper interfacing structure 356 and the lower interfacing structure 358 may establish a T-shaped cross-section of the structural barrier 350. However, other shapes are contemplated within the scope of this disclosure.

The upper interfacing structure 356 may include an upper surface 360 and a pair of wiper gaskets 376 that protrude outwardly from the upper surface 360. One wiper gasket 376 may be provided near each outboard edge 366 of the upper interfacing structure 356.

The upper surface 360 and the wiper gaskets 376 may cooperate to establish a pocket 364 for receiving and holding an adhesive 68. The adhesive 68 can secure the thermal barrier assembly 34 to the upper enclosure structure. The wiper gaskets 376 may each extend to a height that is proud of at least a portion of the adhesive 68 and can thus function to prevent the adhesive 68 from flowing or dripping off of the upper interfacing structure 356 prior to curing.

Once the upper enclosure structure is secured to the structural barrier 350 by the adhesive 68, the sealed joint established therebetween can substantially prevent thermal energy from moving from one compartment of the cell stack to another, such as during a battery thermal event, for example. The wiper gaskets 376 can flex relative to the upper interfacing structure 356 as the upper enclosure structure is moved into contact with the wiper gaskets 376. The wiper gaskets 376 may therefore interface directly against an inner surface of the upper enclosure structure to provide additional sealing, thereby acting as flexible barriers that can prevent thermal energy from melting or debonding the adhesive 68 during such a battery thermal event.

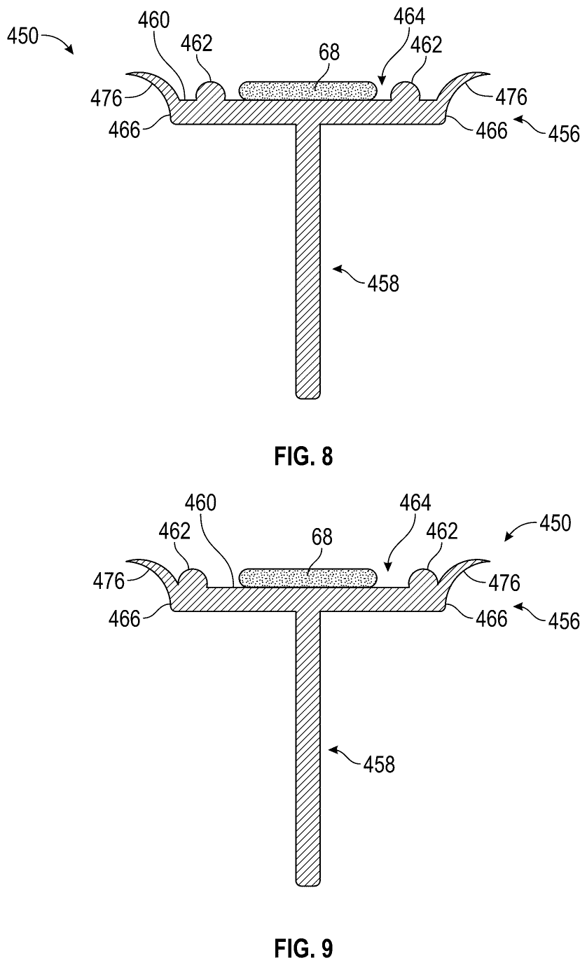

FIG. 8 illustrates another exemplary structural barrier 450 that could be utilized as part of the thermal barrier assembly 34 described above. The structural barrier 450 may include an upper interfacing structure 456 that is configured to interface with an upper enclosure structure of the traction battery pack 18, and a lower interfacing structure 458 that is configured to interface with a lower enclosure structure of the traction battery pack 18. Together, the upper interfacing structure 456 and the lower interfacing structure 458 may establish a T-shaped cross-section of the structural barrier 450. However, other shapes are contemplated within the scope of this disclosure.

The upper interfacing structure 456 may include an upper surface 460, a pair of beads 462, and a pair of wiper gaskets 476. The wiper gaskets 476 may protrude outwardly from the upper surface 460. One wiper gasket 476 may be provided near each outboard edge 466 of the upper interfacing structure 356. The beads 462 may also protrude outwardly from the upper surface 460 at a location that is onboard from the wiper gaskets 476. A gap may extend between the beads 462 and the wiper gaskets 476 (see FIG. 8). Alternatively, the wiper gaskets 476 may extend directly from the beads 462 (see FIG. 9).

The upper surface 460 and the beads 462 may cooperate to establish a pocket 464 for receiving and holding an adhesive 68. The adhesive 68 can secure the thermal barrier assembly 34 to the upper enclosure structure.

The beads 462 may each extend to a height that is proud of at least a portion of the adhesive 68 and can thus function to prevent the adhesive 68 from flowing or dripping off of the upper interfacing structure 456 prior to curing. The beads 462 may additionally function to support the upper enclosure structure and can act as depth stops and/or compression limiters as the upper enclosure structure is moved into contact with the structural barrier 450 during assembly of the traction battery pack 18.

Once the upper enclosure structure is secured to the structural barrier 450 by the adhesive 68, the sealed joint established therebetween can substantially prevent thermal energy from moving from one compartment to another, such as during a battery thermal event, for example. The wiper gaskets 476 may flex relative to the upper interfacing structure 456 as the upper enclosure structure is moved into contact with the wiper gaskets 476. The wiper gaskets 476 may therefore interface directly against an inner surface of the upper enclosure structure to provide additional sealing, thereby acting as flexible barriers that can prevent thermal energy from melting or debonding the adhesive 68 during any such battery thermal event.

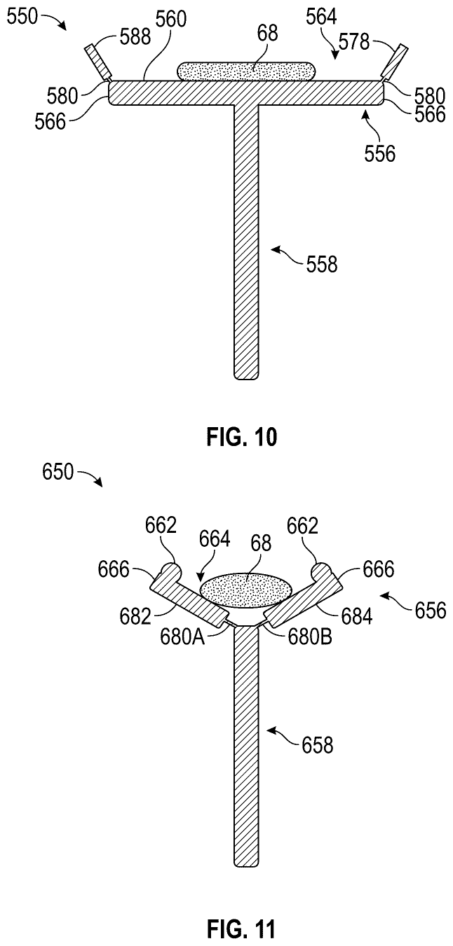

FIG. 10 illustrates another exemplary structural barrier 550 that could be utilized as part of the thermal barrier assembly 34 described above. The structural barrier 550 may include an upper interfacing structure 556 that is configured to interface with an upper enclosure structure of the traction battery pack 18, and a lower interfacing structure 558 that is configured to interface with a lower enclosure structure of the traction battery pack 18. Together, the upper interfacing structure 556 and the lower interfacing structure 558 may establish a T-shaped cross-section of the structural barrier 550. However, other shapes are contemplated within the scope of this disclosure.

The upper interfacing structure 556 may include an upper surface 560. One or more flaps 578 may be movably connected to the upper interfacing structure 556 by a hinge 580. The flaps 578 may protrude to a location that is outward from the upper surface 560. One flap 578 may be provided near each outboard edge 566 of the upper interfacing structure 356.

The upper surface 560, the flaps 578, and the hinges 580 may cooperate to establish a pocket 564 for receiving and holding an adhesive 68. The adhesive 68 can secure the structural barrier 550 of the thermal barrier assembly 34 to the upper enclosure structure. The flaps 578 may each extend to a height that is proud of at least a portion of the adhesive 68 and can thus function to prevent the adhesive 68 from flowing or dripping off of the upper interfacing structure 556 prior to curing.

Once the upper enclosure structure is secured to the structural barrier 550 by the adhesive 68, the sealed joint established therebetween can substantially prevent thermal energy from moving from one compartment to another across the cells stack 22, such as during a battery thermal event, for example. The flaps 578 can flex about the hinges 580 relative to the upper interfacing structure 556 as the upper enclosure structure is moved into contact with the flaps 578. The flaps 578 may therefore interface directly against an inner surface of the upper enclosure structure to provide additional sealing, thereby acting as flexible barriers that can prevent thermal energy from melting or debonding the adhesive 68 during any such battery thermal event.

FIG. 11 illustrates another exemplary structural barrier 650 that could be utilized as part of the thermal barrier assembly 34 described above. The structural barrier 650 may include an upper interfacing structure 656 that is configured to interface with an upper enclosure structure, and a lower interfacing structure 658 that is configured to interface a lower enclosure structure.

The upper interfacing structure 656 may include a first wall section 682 and a second wall section 684. The first wall section 682 may be connected to the lower interfacing structure 658 by a first hinge 680A, and the second wall section 684 may be connected to the lower interfacing structure 658 by a second hinge 680B.

A bead 662 may protrude from each of the first wall section 682 and the second wall section 684. The beads 662 may be provided near outboard edges 666 of the first and second wall sections 682, 684.

The first and second wall sections 682, 684, the first and second hinges 680A, 680B, and the beads 662 may cooperate to establish a pocket 664 for receiving and holding an adhesive 68. The adhesive 68 secures the structural barrier 650 of the thermal barrier assembly 34 to the upper enclosure structure. The beads 662 may function to prevent the adhesive 68 from flowing or dripping off of the upper interfacing structure 656 prior to curing.

Once the upper enclosure structure is secured to the structural barrier 650 by the adhesive 68, the sealed joint established therebetween can substantially prevent thermal energy from moving from one compartment to another, such as during a battery thermal event, for example. The first and second wall sections 682, 684 can flex about the first hinge 680A and the second hinge 680B, respectively, as the upper enclosure structure is moved into contact with the beads 662. The beads 662 may function to support the upper enclosure structure and can act as depth stops and/or compression limiters as the upper enclosure structure is moved into contact with the structural barrier 650. The beads 662 may further interface directly against an inner surface of the upper enclosure structure to provide additional sealing, thereby acting as flexible barriers that can prevent thermal energy from melting or debonding the adhesive 68 during any such battery thermal event.

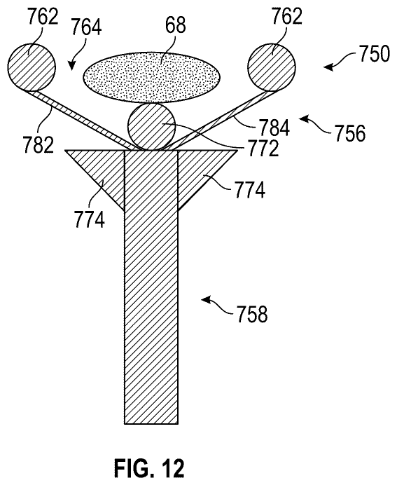

FIG. 12 illustrates yet another exemplary structural barrier 750 that could be utilized as part of the thermal barrier assembly 34 described above. The structural barrier 750 may include an upper interfacing structure 756 that is configured to interface with an upper enclosure structure, and a lower interfacing structure 758 that is configured to interface with a lower enclosure structure of the traction battery pack 18.

The upper interfacing structure 756 may include a first wall section 782 and a second wall section 784. The first wall section 782 and the second wall section may each be connected to the lower interfacing structure 758.

A bead 762 may protrude from each of the first wall section 782 and the second wall section 784. The beads 762 may be provided near outboard edges of the first and second wall sections 782, 784.

The first and second wall sections 782, 784 and the beads 762 may cooperate to establish a pocket 764 for receiving and holding an adhesive 68. The adhesive 68 can secure the structural barrier 750 of the thermal barrier assembly 34 to the upper enclosure structure. The beads 762 may function to prevent the adhesive 68 from flowing or dripping off of the upper interfacing structure 756 prior to curing.

Once the upper enclosure structure is secured to the structural barrier 750 by the adhesive 68, the sealed joint established therebetween can substantially prevent thermal energy from moving from one compartment 36 to another, such as during a battery thermal event, for example. The first and second wall sections 782, 784 can flex relative to the lower interfacing structure 758 as the upper enclosure structure is moved into contact with the beads 762. The beads 762 may function to support the upper enclosure structure and can act as depth stops and/or compression limiters as the upper enclosure structure is moved into contact with the structural barrier 750. The beads 762 may further interface directly against an inner surface of the upper enclosure structure to provide additional sealing, thereby acting as flexible barriers that can prevent thermal energy from melting or debonding the adhesive 68 during such a battery thermal event.

The structural barrier 750 may include an additional bead 772 that is secured to or protrudes from an uppermost surface of the lower interfacing structure 758. The bead 772 is axially aligned with lower interfacing structure 758 of the structural barrier 750. The bead 772 is therefore better positioned to direct columnar loads from the upper enclosure structure through the structural barrier 750 by establishing a more direct vertical load path through the lower interfacing structure 758.

The structural barrier 750 may additionally include one or more buttresses 774 that extend diagonally toward the first and second wall sections 782, 784 from the lower interfacing structure 758. The buttresses 774 may delimit the flexible movement of the first and second wall sections 782, 784 and may increase the structural integrity of the upper interfacing structure 756, thereby allowing the structural barrier 750 to better support the weight of the upper enclosure structure.

The thermal barrier assemblies of this disclosure provide for blocking gases and protecting adhesive from vent gas temperatures and debris while maintaining structure, sealing, and thermal resistance in a relatively thin profile compared to prior thermal barriers. The exemplary thermal barrier assemblies may include a barrier structure designed to retain the adhesive during curing to limit spillage onto battery cells and/or to support the weight of battery enclosure structures.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a thermal barrier assembly arranged to partition the battery cell stack into at least a first compartment and a second compartment;
a structural barrier of the thermal barrier assembly including an upper interfacing structure that provides a pocket; and
an adhesive received within the pocket for structurally coupling the upper interfacing structure to an upper enclosure structure of the traction battery pack.

2. The traction battery pack as recited in claim 1, wherein the upper enclosure structure is part of an enclosure cover of the traction battery pack.

3. The traction battery pack as recited in claim 1, wherein the structural barrier includes a T-shaped cross-section.

4. The traction battery pack as recited in claim 1, wherein the structural barrier is a pultrusion.

5. The traction battery pack as recited in claim 1, wherein the structural barrier is part of a multi-layer sandwich structure of the thermal barrier assembly.

6. The traction battery pack as recited in claim 1, wherein the upper interfacing structure includes an upper surface and a pair of beads that protrude outwardly from the upper surface, and further wherein the upper surface and the pair of beads cooperate to establish the pocket.

7. The traction battery pack as recited in claim 6, wherein each bead of the pair of beads extends to a height above the upper surface, and the adhesive includes a thickness that is about equal to the height.

8. The traction battery pack as recited in claim 6, wherein an additional bead protrudes from the upper surface at a location between a first bead of the pair of beads and a second bead of the pair of beads.

9. The traction battery pack as recited in claim 1, wherein the structural barrier includes a lower interfacing structure that is connected to the upper interfacing structure and is configured to interface with a lower enclosure structure of the traction battery pack.

10. The traction battery pack as recited in claim 9, wherein the structural barrier includes a buttress that extends between the lower interfacing structure and the upper interfacing structure.

11. The traction battery pack as recited in claim 1, wherein the upper interfacing structure includes an upper surface and a pair of wiper gaskets that protrude outwardly from the upper surface.

12. The traction battery pack as recited in claim 1, wherein the upper interfacing structure includes an upper surface and a pair of flaps that are movably connected to the upper interfacing structure.

13. The traction battery pack as recited in claim 1, wherein the upper interfacing structure includes a first wall section and a second wall section that are each pivotably connected to a lower interfacing structure of the structural barrier.

14. A traction battery pack, comprising:
an upper enclosure structure;
a thermal barrier assembly including a structural barrier configured to establish a first sealed interface relative to the upper enclosure structure;
the structural barrier including an upper interfacing structure that includes a pocket; and
an adhesive received within the pocket for securing the upper enclosure structure to the structural barrier.

15. The traction battery pack as recited in claim 14, wherein the structural barrier is a pultruded structure of the thermal barrier assembly.

16. The traction battery pack as recited in claim 14, wherein the upper interfacing structure includes an upper surface and a first bead and a second bead that each protrudes outwardly from the upper surface.

17. The traction battery pack as recited in claim 16, comprising a third bead that protrudes outwardly from the upper surface at a location between the first bead and the second bead.

18. The traction battery pack as recited in claim 14, wherein the upper interfacing structure includes an upper surface and a pair of wiper gaskets that protrude outwardly from the upper surface.

19. The traction battery pack as recited in claim 14, wherein the upper interfacing structure includes an upper surface and a pair of flaps that are movably connected to the upper interfacing structure.

20. The traction battery pack as recited in claim 14, wherein the upper interfacing structure includes a first wall section and a second wall section that are each pivotably connected to a lower interfacing structure of the structural barrier.
